(19) United States
(12) Patent Application Publication
(10) Pub. No.: US 2010/0246910 A1
(43) Pub. Date: Sep. 30, 2010

(54) METHOD OF AUTOMATICALLY CORRECTING MIS-ORIENTATION OF MEDICAL IMAGES

(75) Inventors: Rafael Wiemker, Kisdorf (DE); Thomas Buelow, Grosshansdorf (DE); Hans Barschdorf, Dassendorf (DE); Kirsten Meetz, Hamburg (DE); Heinrich Schulz, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/741,838

(22) PCT Filed: Nov. 10, 2008
(86) PCT No.: PCT/IB08/54699

§ 371 Date: May 7, 2010

(30) Foreign Application Priority Data
Nov. 14, 2007 (EP) 07120683.3

(51) Int. Cl. G06K 9/00

(52) U.S. Cl. 382/128; 382/296

(57) ABSTRACT

This invention relates to a method and image processing apparatus for automatically correcting mis-orientation of medical images. One or more image processing software modules are used to extract (101) anatomical areas from the medical images. It is determined (103) whether the extracted anatomical areas correspond to reference anatomical areas, but the reference anatomical areas have associated thereto data indicating the orientation of the reference anatomical areas. If the extracted anatomical areas correspond with the reference anatomical areas, the true orientation of the extracted anatomical areas is determined (105) by realigning the medical image until the orientation of the extracted anatomical areas corresponds to the orientation of the reference anatomical areas.

### FIELD OF THE INVENTION

The present invention relates to a method and an image processing apparatus for automatically correcting mis-orientation of medical images.

### BACKGROUND OF THE INVENTION

Many vendors in the medical imaging industry have established a communication standard to allow medical image data to be transmitted and processed by a plurality of disparate systems. One common standard is the Digital Imaging and Communications in Medicine (DICOM) protocol, which is a standard for image and information transmission and relates to transfers of electronic data, such as medical images and associated meta-data, between medical diagnostic and/or imaging systems. The DICOM protocol may be employed in communication between medical devices and images archives, such as picture archiving and communication systems (PACS).

The problem is, however, that the images coming out of e.g. hospitals' PACS are sometimes mis-oriented, e.g. mirrored or turned upside down. Such mis-orientations may occur when images are used, i.e. read-in, processed and written-back, by incompatible devices, e.g. when they are uploaded from an image acquisition apparatus into an image archiving system. In particular, the directions of the x-, y- and z-axes are often reversed. In principle, the directions are coded in the image meta-data stored in the DICOM header of the image. However, for various reasons this information may be either not available or wrong, e.g. after repeated export/import through systems from different vendors. The meta-data describing the orientation of the image may be e.g. missing, erroneous, inconsistent or ambiguous. This may cause the following problems: i) for human readers any obvious mis-orientations (e.g. the image is up-side down) cost additional time, because the readers have to use a functionality of the visualization application to manually correct the orientation; in the case of large volume data sets, the readers may also have to wait for correcting the orientation of the image data; if the mis-orientation of the stored image data is not corrected, the correcting may have to be repeated every time the image data is retrieved for viewing, ii) subtle mis-orientations, which are not immediately obvious to human readers, may lead to false diagnoses and oversight errors, and iii) for automatic image processing algorithms such as computer aided detection and diagnosis algorithms (CAD) a mis-orientation may have severe consequences because many of these algorithms will fail if the image is not correctly oriented.

### BRIEF DESCRIPTION OF THE INVENTION

The object of the present invention is to overcome the above mentioned drawbacks by providing a method and a system allowing mis-oriented medical images to be corrected automatically.

According to one aspect, the present invention relates to a method of automatically correcting mis-orientation of a medical image, the method comprising:
providing one or more image processing software modules, adapted to extract anatomical areas from the medical image, and extracting the anatomical areas from the medical image,
determining whether the extracted anatomical areas correspond to reference anatomical areas, the reference anatomical areas having associated thereto data indicating the orientation of the reference anatomical areas,
   and, if the extracted anatomical areas correspond to the reference anatomical areas,
determining a true orientation of the extracted anatomical areas by realigning the medical image until the orientation of the extracted anatomical areas corresponds to the orientation of the reference anatomical areas.

Therefore, an automatic way is provided for correcting mis-orientations of medical images, thereby reducing the possibility of false diagnoses due to a mis-orientation. Advantageously, the method of the invention is arranged to save time of a clinician viewing the medical image by automatically correcting possible mis-orientation. A person skilled in the art will understand that in an equivalent embodiment, the reference image may be realigned instead of the medical image and the true orientation of the extracted anatomical areas may be determined based on the orientation of the realigned reference image.

In one embodiment, the method further comprises adding data indicating the orientation of the reference anatomical areas as meta-information to the medical image when the orientation of the extracted anatomical areas corresponds to the orientation of the reference anatomical areas, or, if the medical image has erroneous or inconsistent meta-information indicating the orientation of the medical image, replacing the erroneous or inconsistent meta-information with the data indicating the orientation of the reference anatomical areas.

Since the meta-information indicating the orientation of the medical image may be not available, wrong or inconsistent, e.g. after repeated export/import between systems made by different manufacturers, a very effective and user friendly way is provided for either adding or correcting the meta-information by indicating the true orientation of the medical image.

In one embodiment, multiple image-processing software modules are used to extract the anatomical areas from the medical image, each of the multiple modules being adapted for a specific imaging modality and specific anatomical areas, the specific anatomical areas being the areas defining the reference anatomical areas.

Accordingly, each of the image-processing software modules may be designed for a specific imaging modality, such as computed tomography (CT), Magnetic Resonance Imaging (MRI), X-ray, etc., and specific anatomical areas such as thorax, head, abdomen, breast, etc. Thus, by combining multiple image-processing software modules it is possible to correct the mis-orientation in a large variety of medical images.

In one embodiment, the step of determining the true orientation of the extracted anatomical areas comprises realigning the medical image until contour lines of the extracted anatomical areas are substantially fit with contour lines of the reference anatomical areas.

In one embodiment, the reference anatomical areas are comprised in pre-stored reference medical images, the step of determining the true orientation of the extracted anatomical areas comprising determining a measure of similarity between the extracted anatomical areas and the reference anatomical areas for each alignment of the medical image, the true orientation being an orientation corresponding to an alignment of the medical image where the similarity measure is above a similarity threshold value.

The similarity measure may be pre-defined and is based on how well the extracted anatomical areas comprised in the realigned medical image are fit with the reference anatomical areas. The orientation of the extracted anatomical areas may be changed during realigning the medical image e.g. by rotating the image about a rotation axis, taking a mirror reflection of the medical image, etc. After each attempt to align the medical image, the measure of similarity between the extracted anatomical areas and the reference anatomical areas is computed. The medical image is realigned until the measure of similarity exceeds the similarity threshold value. Optionally, the measure of similarity may be computed for a plurality of realigned medical images. If two or more realigned extracted anatomical structures and the reference anatomical structures have similarity values greater than the similarity threshold value, the alignment of the extracted anatomical structure corresponding to the highest value of the similarity measure may be used to determine the true orientation of the medical image.

In one embodiment, determining the true orientation of the extracted anatomical areas is based on determining a measure of confidence defining the probability that the extracted anatomical areas are aligned with the reference anatomical areas, and the anatomical areas being considered to be aligned with the reference anatomical areas when the confidence measure is above a confidence threshold value.

Using such a confidence measure can be very useful because the extracted anatomical areas are often not exactly fit with the reference anatomical areas. Therefore, the confidence measure helps to describe how the extracted anatomical areas correspond to the reference anatomical areas.

In one embodiment, multiple image modules are used to extract the anatomical areas from the medical image, each of the multiple modules being adapted for a specific imaging modality and specific anatomical areas, the specific anatomical areas being the areas defining the reference anatomical areas, the step of determining whether the extracted anatomical areas correspond to the reference anatomical areas being performed in a hierarchical fashion by initially employing those image processing modules which are adapted to discriminate between different image modalities or specific anatomical areas.

Accordingly, it is possible to avoid the subsequent unnecessary use of certain other modules which are not applicable, and thus to accelerate the overall process. As an example, the modules employed first may be modules which determine the most probable modality used to acquire the medical image (e.g. x-ray, CT, MRI) and the modules employed next may be modules which determine the most probable body region described by the medical image, e.g. head, thorax, abdomen, or the whole body.

In one embodiment, the medical image is stored in a Digital Imaging and Communications in Medicine (DICOM) file of a healthcare provider's picture archiving system (PACS).

According to another aspect, the present invention relates to a computer program product for instructing a processing unit to execute the steps of the method of the invention when the product is run on a computer.

According to still another aspect, the present invention relates to an image processing apparatus for automatically correcting mis-orientation of a medical image, comprising:
a processor operable in conjunction with one or more image processing software modules for extracting anatomical areas from the medical image, the processor being adapted to determine whether the extracted anatomical areas correspond to reference anatomical areas, the reference anatomical areas having associated thereto data indicating the orientation of the reference anatomical areas, and, if the extracted anatomical areas correspond to the reference anatomical areas, to determine a true orientation of the extracted anatomical areas by realigning the medical image until the orientation of the extracted anatomical areas corresponds to the orientation of the reference anatomical areas.

According to still another aspect, the present invention relates to an image acquisition apparatus comprising the image processing apparatus.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a flowchart of the method of automatically correcting mis-orientation of medical images according to the invention,

FIG. 2 shows two exemplary images comprising sagittal views computed from CT volume data,

FIG. 3 illustrates an embodiment of the method of the invention,

FIG. 4 shows examples of contours useful for determining a true orientation of anatomical areas extracted from a medical image,

FIG. 5 schematically shows a block diagram of an exemplary embodiment of the image processing apparatus for automatically correcting mis-orientation of medical images according to the invention, and

FIG. 6 schematically shows an exemplary embodiment of the image acquisition apparatus employing the image processing apparatus of the invention.

### DESCRIPTION OF EMBODIMENTS

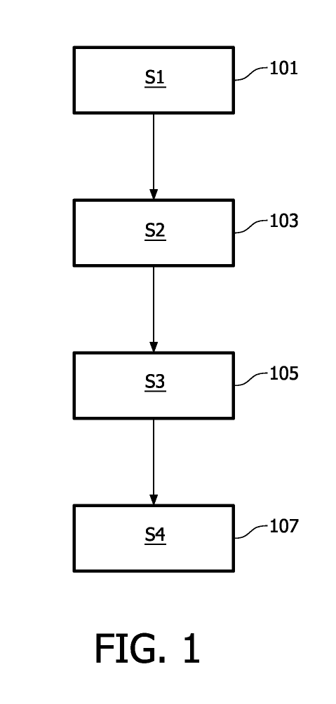

FIG. 1 shows a flowchart of the method of automatically correcting mis-orientation of medical images. The medical images may be stored in the Digital Imaging and Communications in Medicine (DICOM) format in a picture archiving system (PACS) of a healthcare provider.

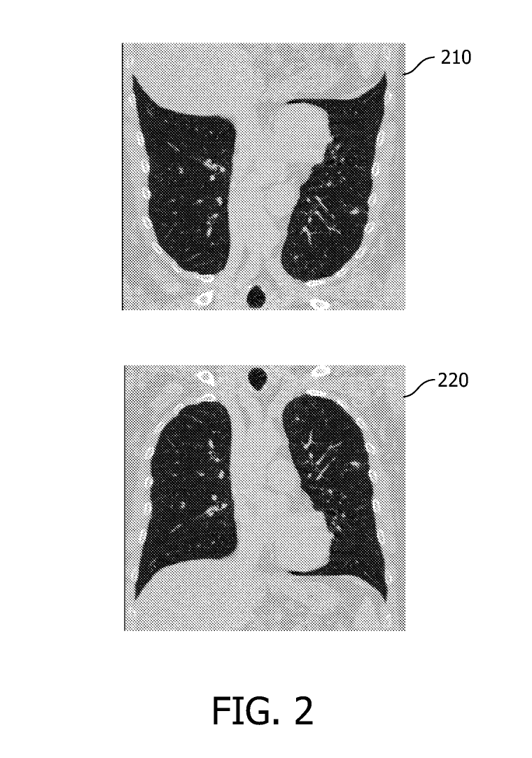

FIG. 2 shows two exemplary images comprising sagittal views computed from CT volume data. The first image 210 is mis-oriented. The second image 220 is shown in a proper orientation used by radiologists for viewing thorax images, hereinafter also referred to as true orientation.

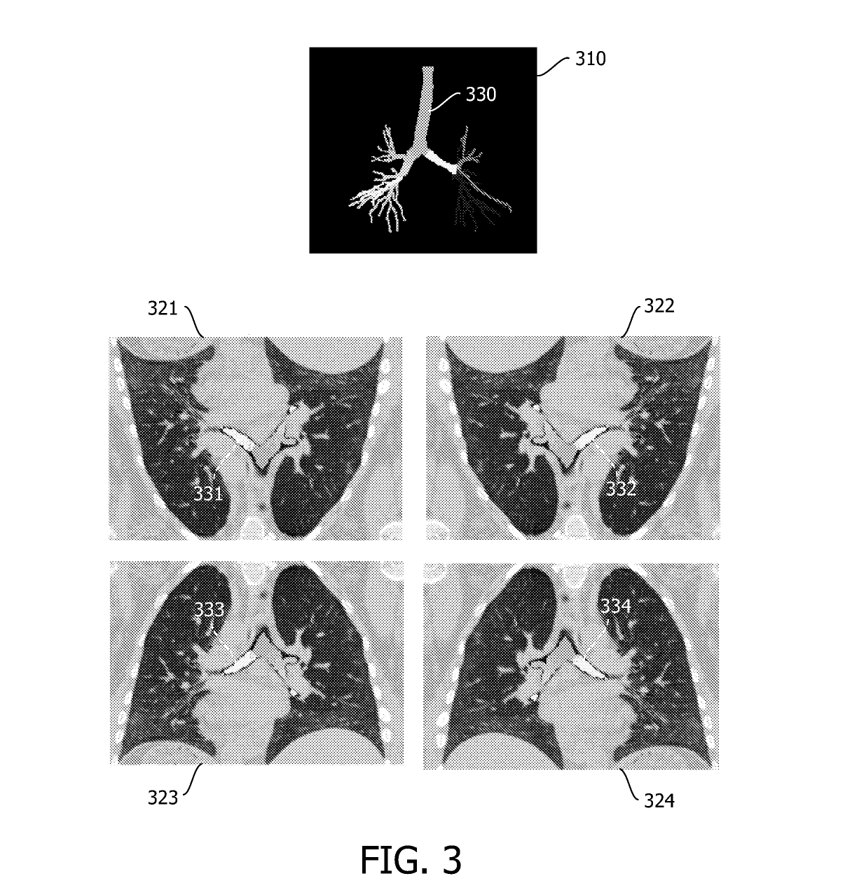

FIG. 3 illustrates an embodiment of the method of the invention. The top image 310 illustrates the reference anatomical area—a tracheo-bronchial tree. The skilled person will appreciate that the term “area” used in the description of the invention must not be construed to be a two-dimensional (2-D) region. This term may also refer to a three-dimensional (3-D) region. Similarly, the term “image” may refer to a 2-D or to a 3-D image. A reference anatomical area describing a tracheo-bronchial tree may be obtained from a reference image, using image segmentation.

The four bottom images 321-324 show four sagittal views of the thorax in different orientations. A part of the tracheo-bronchial tree 330 visible in each of the four images 321-324 is also shown. The fourth image 324 is in the true orientation. The first image 321 is rotated about an axis perpendicular to the viewing plane by 180 deg. The second image 322 is a mirror reflection of the fourth image 324 in respect to a horizontal plane perpendicular to the viewing plane. The third image 323 is a mirror reflection of the fourth image 324 in respect to a vertical plane perpendicular to the viewing plane.

In step S1, at least one image processing software module for extracting anatomical areas from the medical images is provided 101. Each image processing software module is based on an algorithm for extracting anatomical areas from the medical image. Such algorithms may include e.g. object detection and/or image segmentation. Further, in step S1, the modules are used for extracting 101 the anatomical areas (e.g. an organ or organ parts) from the medical image, where each of the multiple modules may be adapted for a specific imaging modality and specific anatomical areas. For example, the algorithm may be arranged for extracting a tracheo-bronchial tree shown in FIG. 3, spine, lung, liver, breast etc. Each module may be designed for a specific imaging modality, e.g. CT, MRI, X-ray etc, and a specific anatomical area, e.g. thorax, head, abdomen, etc.

Step S2 is arranged for determining 103 whether the extracted anatomical areas correspond to reference anatomical areas. Here it is assumed that the reference anatomical areas have associated thereto data indicating the orientation of the reference anatomical areas. This data may be used to define the true orientation of the reference anatomical area.

In an embodiment, the size of the extracted anatomical areas is compared to the size of reference anatomical areas. If the size of the extracted anatomical areas is substantially the same as the size of the reference anatomical areas, the extracted anatomical areas are determined to correspond to the reference anatomical areas. Optionally, a plurality of trial anatomical areas extracted from the medical image may be analyzed. The trial anatomical areas with a size best matching the size of the reference anatomical areas are determined to be the extracted anatomical areas. Optionally, step S2 may be combined with step S1, e.g. using an image registration technique for registering the reference anatomical area with the anatomical image. This method may be used to extract the tracheo-bronchial trees in the four bottom images 321-324 in FIG. 3. Advantageously, the registration transformation may be used to determine the true orientation of the extracted anatomical areas.

Step S3 is arranged for determining 105 the true orientation of the extracted anatomical areas. This is done by realigning the medical image until the orientation of the extracted anatomical areas corresponds to the orientation of the reference anatomical areas. Such a realigning may include scaling, translations, rotations and mirror reflections of the image. A few exemplary orientations which may be produced by realignment of the medical image are shown in FIG. 3. In each of the images 321-323, the extracted tracheo-bronchial tree 331-333, respectively, is not fit well with the reference tracheo-bronchial tree 330. The first image 321 must be realigned by rotating it 180 deg about an axis perpendicular to the viewing plane. The second image 322 must be realigned by reflecting it in respect to a horizontal plane perpendicular to the viewing plane. The third image 323 must be realigned by reflecting it in respect to a vertical plane perpendicular to the viewing plane. As a result of this realignment, the first, second and third image may be aligned with the reference tracheo-bronchial tree 330. The fourth image does not need to be realigned. The extracted tracheo-bronchial tree 334 fits the reference tracheo-bronchial tree 330. Optionally, step S3 may be combined with any one of steps S1 and S2.

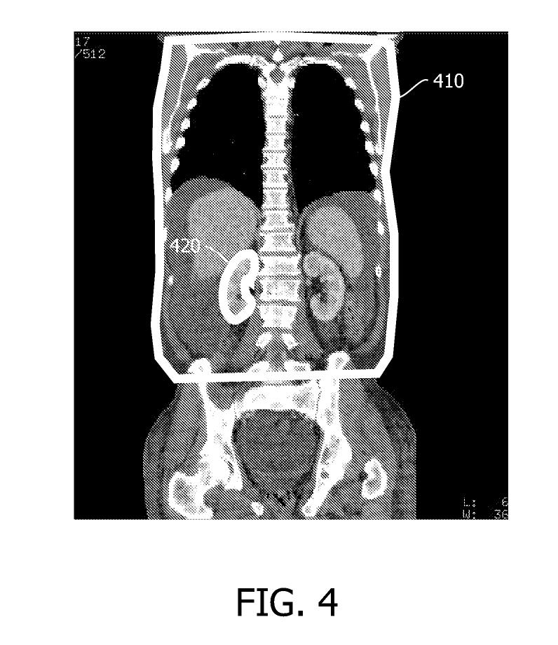

In one embodiment, the step of determining the true orientation of the extracted anatomical areas comprises realigning the medical image until contour lines of the extracted anatomical areas are substantially fit with contour lines of the reference anatomical areas. FIG. 4 shows two examples of contours useful for determining a true orientation of anatomical areas extracted from a medical image. The first exemplary contour 410 is a contour of the torso, the second exemplary contour 420 is a kidney contour. In further embodiments, other shape features of the extracted anatomical areas may be determined and compared with the corresponding shape features of the reference anatomical areas. These shape features include, but are not limited to, the statistical moments of the distribution of image intensities, the location of the mass center, the moment of inertia and higher moments computed based on the spatial distribution of image intensities.

In one embodiment, the method further includes step S4 for adding 107 the data indicating the orientation of the reference anatomical areas as meta-information to the medical image after correct realignment of the medical image, when the orientation of the extracted anatomical areas corresponds to the orientation of the reference anatomical areas. Also, if the medical image has erroneous or inconsistent meta-information indicating the orientation of the medical image, the erroneous or inconsistent meta-information is replaced with the data indicating the orientation of the reference anatomical areas.

A clinician may be involved in a step of the method. For example, the clinician may indicate, using a user input device such as a mouse or a microphone, that a certain medical image is mis-oriented or that image-orientation metadata is missing or inconsistent. Also, the clinician may be notified that the medical image orientation metadata is changed or that the orientation metadata is added to the medical image. Finally, a view of a realigned medical image may be presented to the clinician for a quick verification.

In one embodiment, determining whether the extracted anatomical areas correspond to the reference anatomical areas is performed in a hierarchical way using multiple image processing software modules. For example, first an imaging modality, e.g. CT or MRI, may be determined. Next a specific anatomical area may be determined, e.g. head or thorax. Consequently, further determining whether the extracted anatomical area corresponds to the reference anatomical area may be carried out using image processing software modules and methods specific to CT or MRI images of the brain or thorax, respectively.

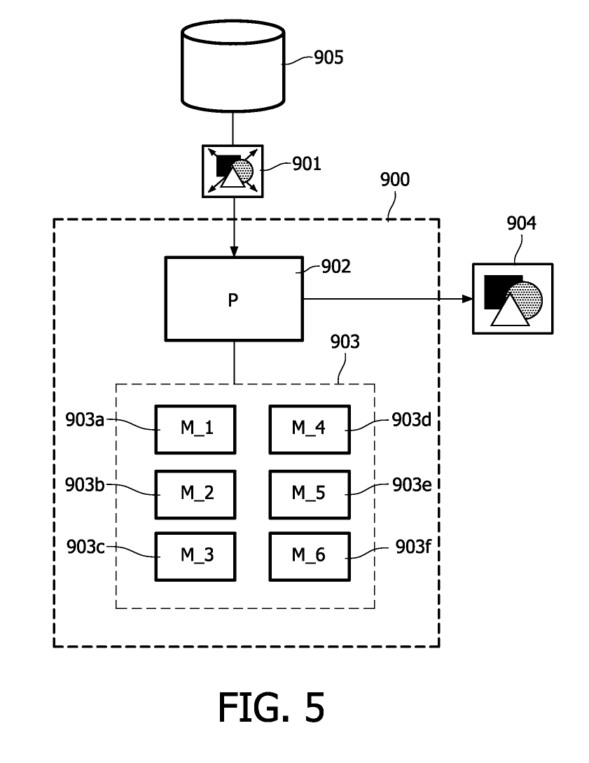

FIG. 5 shows an image processing apparatus 900 for automatically correcting mis-orientation of a medical image 901. The apparatus comprises a processor 902 operable in conjunction with one or more image processing software modules 903a-903f comprised in an ensemble 903 of modules. The modules are adapted to extract anatomical areas from the medical image 901 stored in a memory 905, e.g. in an image archiving system in a hospital. The apparatus 900 may be implemented by a workstation located in the clinician's office or with the image archive. The processor 902 which is operated in conjunction with the image processing software modules ensemble 903 determines whether the extracted anatomical areas correspond to reference anatomical areas. The reference anatomical areas have associated thereto data indicating the orientation of the reference anatomical areas. If the extracted anatomical areas correspond to the reference anatomical areas, the processor is arranged to determine the true orientation of the extracted anatomical areas by realigning the medical image until the orientation of the extracted anatomical areas corresponds to the orientation of the reference anatomical areas. The output of the apparatus 900 may be the medical image 904 with an orientation corresponding to the orientation of the reference image. The system may be used by the clinician viewing the medical image. In an embodiment, the system is used for orienting the medical image before adding it to the image archiving system.

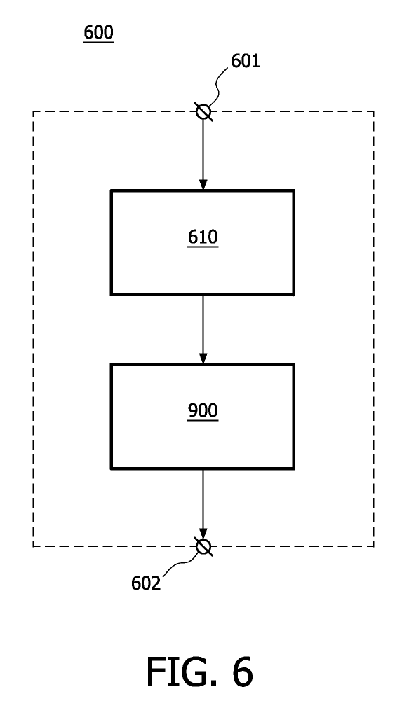

FIG. 6 schematically shows an exemplary embodiment of the image acquisition apparatus 600 employing the image processing apparatus 900 of the invention, said image acquisition apparatus 600 comprising a CT image acquisition unit 610 connected via an internal connection with the image processing apparatus 900, an input connector 601, and an output connector 602. This arrangement advantageously increases the capabilities of the image acquisition apparatus 600, providing said image acquisition apparatus 600 with advantageous capabilities of the image processing apparatus 900.

Certain specific details of the disclosed embodiment are set forth for purposes of explanation rather than limitation, so as to provide a clear and thorough understanding of the present invention. However, it should be understood by those skilled in this art that the present invention might be practiced in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims; however the inclusion of the reference signs is only for clarity reasons and should not be construed as limiting the scope of the claims.

1. A method of automatically correcting mis-orientation of a medical image, comprising:
providing (101) one or more image processing software modules, adapted to extract anatomical areas from the medical image, and extracting (101) the anatomical areas from the medical image,
determining (103) whether the extracted anatomical areas correspond to reference anatomical areas, the reference anatomical areas having associated thereto data indicating the orientation of the reference anatomical areas,
and, if the extracted anatomical areas correspond to the reference anatomical areas,
determining (105) a true orientation of the extracted anatomical areas by realigning the medical image until the orientation of the extracted anatomical areas corresponds to the orientation of the reference anatomical areas.

2. A method according to claim 1, further comprising adding (107) data indicating the orientation of the reference anatomical areas as meta-information to the medical image when the orientation of the extracted anatomical areas corresponds to the orientation of the reference anatomical areas, or, if the medical image has erroneous or inconsistent meta-information indicating the orientation of the medical image, replacing (107) the erroneous or inconsistent meta-information with the data indicating the orientation of the reference anatomical areas.

3. A method according to claim 1, wherein multiple image processing software modules are used to extract the anatomical areas from the medical image, each of the multiple modules being adapted for a specific imaging modality and specific anatomical areas, the specific anatomical areas being the areas defining the reference anatomical areas.

4. A method according to claim 1, wherein the step of determining the true orientation of the extracted anatomical areas comprises realigning the medical image until contour lines of the extracted anatomical areas are substantially fit with contour lines of the reference anatomical areas.

5. A method according to claim 1, wherein the reference anatomical areas are comprised in pre-stored reference medical images, the step of determining the true orientation of the extracted anatomical areas comprising determining a measure of similarity between the extracted anatomical areas and the reference anatomical areas for each alignment of the medical image, the true orientation being an orientation corresponding to an alignment of the medical image where the similarity measure is above a similarity threshold value.

6. A method according to claim 1, wherein determining the true orientation of the extracted anatomical areas is based on determining a measure of confidence defining the probability that the extracted anatomical areas are aligned with the reference anatomical areas, and the anatomical areas being considered to be aligned with the reference anatomical areas when the confidence measure is above a confidence threshold value.

7. A method according to claim 1, wherein multiple image modules are used to extract the anatomical areas from the medical image, each of the multiple modules being adapted for a specific imaging modality and specific anatomical areas, the specific anatomical areas being the areas defining the reference anatomical areas, the step of determining whether the extracted anatomical areas correspond to the reference anatomical areas being performed in a hierarchical fashion by initially employing those image processing modules which are adapted to discriminate between different image modalities or specific anatomical areas.

8. A computer program product for instructing a processing unit to execute the method according to claim 1 when the product is run on a computer.

9. An image processing apparatus (900) for automatically correcting mis-orientation of a medical image (901), comprising:
a processor (902) operable in conjunction with one or more image processing software modules (903a-903f) for extracting anatomical areas from the medical image, the processor being adapted to determine whether the extracted anatomical areas correspond to reference anatomical areas, the reference anatomical areas having associated thereto data indicating the orientation of the reference anatomical areas, and, if the extracted anatomical areas correspond to the reference anatomical areas, to determine a true orientation of the extracted anatomical areas by realigning the medical image until the orientation of the extracted anatomical areas corresponds to the orientation of the reference anatomical areas.

10. An image acquisition apparatus comprising the image processing apparatus according to claim 9.
